(19) United States
(12) Patent Application Publication
(10) Pub. No.: US 2025/0130823 A1
(43) Pub. Date: Apr. 24, 2025

(54) CONTEXT-AWARE PERSONAL APPLICATION MEMORY

(71) Applicant: SAP SE, Walldorf (DE)

(72) Inventors: Peter Eberlein, Malsch (DE); Volker Driesen, Heidelberg (DE)

(21) Appl. No.: 18/491,350

(22) Filed: Oct. 20, 2023

(51) Int. Cl. G06F 9/451; G06F 3/0484; G06F 40/40

(52) U.S. Cl. CPC G06F 9/451; G06F 3/0484; G06F 40/40

(57) ABSTRACT

In a computer-implemented method for a context-aware personal application memory (PAM), using an Application Memory Interface (AMIF) and to create captured data from one or more software applications, data related to user actions with the one or more software applications is captured. Using the AMIF and to create enhanced data, the captured data is enhanced with metadata, data, and semantic relations. Using the AMIF and to create filtered data, the enhanced data is filtered. The filtered data is sent by the AMIF to a personal application memory (PAM).

### BACKGROUND

The human brain forgets information. In fact, much of the large amount of information that the brain is exposed to on a daily basis is not entered into the brain's long-term memory and forgotten. Information is also harder to remember when it is complex, includes a large amount of data, or not initially perceived to be important. Although people attempt to offload perceived important information (for example, take notes, create some type of recording, or use computer software) and then to rely on their memory to recall remaining information, there is still a risk that some of the information will be lost.

### SUMMARY

The present disclosure describes a context-aware personal application memory (PAM).

In an implementation, a computer-implemented method, comprises: capturing, using an Application Memory Interface (AMIF) and to create captured data from one or more software applications, data related to user actions with the one or more software applications; enhancing, using the AMIF and to create enhanced data, the captured data with metadata, data, and semantic relations; filtering, using the AMIF and to create filtered data, the enhanced data; and sending, by the AMIF, the filtered data to a PAM.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, the described approach will provide a natural language search capability associated with all applications and data sets, including metadata. Second, stored information is individualized for a user and search is against all data objects, not just selected data objects or data objects changed by the user. Third, the described approach provides a historical search on “what has been viewed” or “what has been browsed.” Fourth, the described approach provides an interface designed to support processes intended for an application(s). Fifth, the described approach makes it potentially possible to find data object instances using a search with similar implementations. Sixth, data can be related and processed based on temporal proximity.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a chart illustrating an example of visualization of context considerations for a context-aware personal application memory (PAM), according to an implementation of the present disclosure.

FIG. 2 is a block diagram illustrating additional components and interactions of a context-aware PAM with respect to an Application Memory Interface (AMIF), according to an implementation of the present disclosure.

FIG. 3 is a flowchart illustrating an example of a computer-implemented method for a context-aware PAM, according to an implementation of the present disclosure.

FIG. 4 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes a context-aware personal application memory (PAM) and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

The human brain forgets information. In fact, much of the large amount of information that the brain is exposed to on a daily basis is not entered into the brain's long-term memory and forgotten. Information is also harder to remember when it is complex, includes a large amount of data, or is not initially perceived to be important. Although people attempt to offload perceived important information (for example, take notes, create some type of recording, or use computer software, applications, or “apps”) and then to rely on their memory to recall remaining information, there is still a risk that some of the information will be lost.

With respect to use of applications, users will typically work with several such applications during the day for different tasks to be performed. In some cases, the applications can be provided by one source and can allow for cross-application integration. Users attempting to offload important information using one or more applications expect that they can then find information in a computer system executing the one or more applications (for example, search abilities or change history. The issue with this strategy is that the stored data typically lacks context and retrieval mechanisms also lack context awareness.

On the other hand, if an application system could provide a user individual storage of data “seen” by the user (that is, data the user worked with/entered as well as the actions performed on the data), the application system could provide an external memory of personal application data. However, even the described external memory would not improve a user's ability to remember information or to quickly look up information that they had forgotten if simply a mass-collection of data.

An “in-app application search” typically does not provide natural language search available for all applications and data sets, especially not on metadata. Search is also not individualized for the user and is on all objects, not just changed by the user. Search is also not historical as to what had been viewed or browsed. Additionally, typically only selected data object attributes are exposed to a search function. Comparing a conversational interface to individual applications, the described approach interface is designed to support standard processes intended by an application and it is potentially possible to find data object instances (for example, using a search function) with the same limitations.

To generate a more useful memory for personal application data, the information needs to be filtered and amended with context and intuitive/efficient search mechanisms to find information need to be provided. Ideally, the search mechanisms would be context-aware (that is, data is not only amended on collection, but a current user context is used when the stored data is accessed. The described approach is of system providing a context-aware PAM “extension,” which is automatically populated with the “correct” data, having been filtered and amended to increase the data's raw value, and which the user can use to look up information quickly and easily, to query for what the user is struggling to remember, or to create summaries and insights with respect to tasks (for example, personal or employment).

As an example, working in sales, Amanda enters sales orders into a sales system all day long. In the afternoon, she receives an internal note that 13″ Laptops by maker A will go on sale next week. She vaguely remembers that one of her customers in New York, USA has placed a large order for these notebooks this morning, and she wants to inform the customer about the upcoming sale and ask them if they wish to cancel their current order and to place a new one next week, so that they are not surprised and frustrated about missing the opportunity. However, Amanda does not remember exactly which customer it was. So, she queries the system: “Who was the customer from New York that placed a large order for 13” maker A laptops this morning?” Having collected all orders Amanda typed in and having access to the master data linked to these orders that includes the location of the customers, the system can easily identify the one customer that matches all given criteria and can help Amanda with her task.

As another example, John travels to his company's subsidiaries occasionally but does not remember the hotel he stayed in the last time he visited their San Francisco, USA office. John only remembers that he liked the hotel and that it was well within his travel budget. So instead of manually browsing through his expense reports to identify the hotel for his last San Francisco trip and looking up the hotel name from there, he simply asks the system: “In what hotel did I stay the last time I travelled to San Francisco?” Having collected John's expense reports from the finance application that include the desired information, the system can easily identify the name of the hotel and help John with booking his next trip in the travel application.

A question is “how can a user search within a history of his or her personal interactions with a number of application systems?” Only a few objects store a change history with user information, and, at best, this information is typically stored for the latest change. As a result, this information would not permit identifying what a single user changed in the past. Access by users us usually only logged for very sensitive data domains (for example, in an audit trail, but the audit trail is detached from operative data). Typically, this information is not stored in the application system, so there is no information on an object level, what a user has viewed, or changed.

If all data from a user interface (UI) (also, “screen,” “UI screen,” “display,” or “UI display”) that a user has called is captured and available for an individual user search, too many irrelevant records with too many useless attributes would be captured, therefore making a search result list too large for efficient processing. Query result lists may not be relevant by themselves, and only selected items may be worthwhile remembering. UIs can contain filtered lists, configured tables with hidden columns. As a result, not all data is seen by the user. On the other hand, the information, which filters are set, and which columns are shown is interesting/useful. Ideally, the result set is condensed to most relevant data.

Users might want to search for attributes not shown on a UI, so captured UI content would not allow this kind of search. An example is a status-variable of status-and-action management architectures representing an internal object state not necessarily displayed on a UI, but relevant for further search.

Access to information capture needs to be intuitive, but basic search and content filtering can be insufficient. If access is cumbersome, unintuitive, and a result is an overwhelming set of data records, users will not accept a provided PAM that operates in this manner. Natural language query possibilities and short summary texts can be a key capability to make a PAM useable in daily work.

The described approach can support an individual user for a set of applications to remember what the user worked on, did, or failed to do. The PAM can track a record of activities performed in application systems by the user, amend data with semantics, context, and correlation support, while building a 360-degree history of both the user's actions and results from the actions. The approach provides a filterable, searchable, and query-able interface to the PAM. In some implementations, the approach supports vendors of applications to add hyper-personalization capabilities to their application solutions. For example, the PAM provides personalization beyond a usual level of personalization like configuring color, UI and content. The PAM “remembers” what was performed and provides individual capabilities, beyond a configurable application. Such as when searching in the PAM, a user receives a personalized response, which is a different response that another user would receive, even if they used the exact same search term.

Having the PAM reasonably filtered for relevance, extended with metadata from application UIs, and amended with related data (context) from applications the user works with, some of which were not even shown to the user, enables creating advanced query capabilities. In some implementations, the added context information and relation-information supports intuitive processing of/access to information using large language models (LLMs) (for example, CHATGPT or other LLMs). While LLM models tend to have certain deficiencies with respect to context, this weakness can be mitigated by automatically enhancing the information in the PAM during data collection. In this way, the collected data can be used as input to pre-trained LLMs (or to train LLMs) to enable natural language interaction with users to intuitively deliver results they are looking for.

In some implementations, captured data can include information on what a user did in the application system, including content of/references to created, changed, and viewed data objects. This data can be amended with identifiers of the data objects, semantic information on the data objects/data models, semantic information of an application (for example, workflow, process, and hierarchy) and application internal attributes, such as status, action management, and error information. The captured data can be stored with a point-in-time a UI was first displayed and active processing time spent on the UI.

In some implementations, information extraction can be facilitated using an Application Memory Interface (AMIF)—a reusable component forwarding information to the PAM. In some implementations, AMIF is pre-configured by application development experts, but can be further fine-tuned by administrators to implement policies such as filtering out person-related or confidential information.

Data stored in the PAM is user individualized, and authorized access using a UI is provided to the user the data was collected for. The PAM is considered a “personal” store without cross-PAM data exchange. Each user of an application can associated with a PAM, and other users do not have access and cannot see what is stored.

A provided UI permits read access to data automatically captured and stored. In its most basic form, users can filter data using the UI (for example, for a certain time range, attribute values, and certain apps being connected). In some implementations, users can also search for data records with fuzzy search, using regular expressions, or other methods. However, as the amount of data collected can quickly become very large and the bare presentation of raw data is difficult to read, a more advanced form of user interface can be provided to leverage advanced collection of substantially enriched data.

With respect to the previously mentioned natural language query interface provided to access the data, a LLM “prompt” can be provided to take a natural language question from a user, who is then provided with data from the PAM and can generate a well-phrased reply in answer to a provided question. For example, the LLM prompt can provide a summary of the data of one or more captured records. In this way, a user working with a set of applications, receives an additional application acting as a middleman: PAM being connected to all other applications and providing automatic capture of information a user views and enters. Since access to the data can be provided using different methodologies, search, filtering and natural language queries, users can quickly access the data. The PAM can be considered a “memory offload” supporting users to remember what they did.

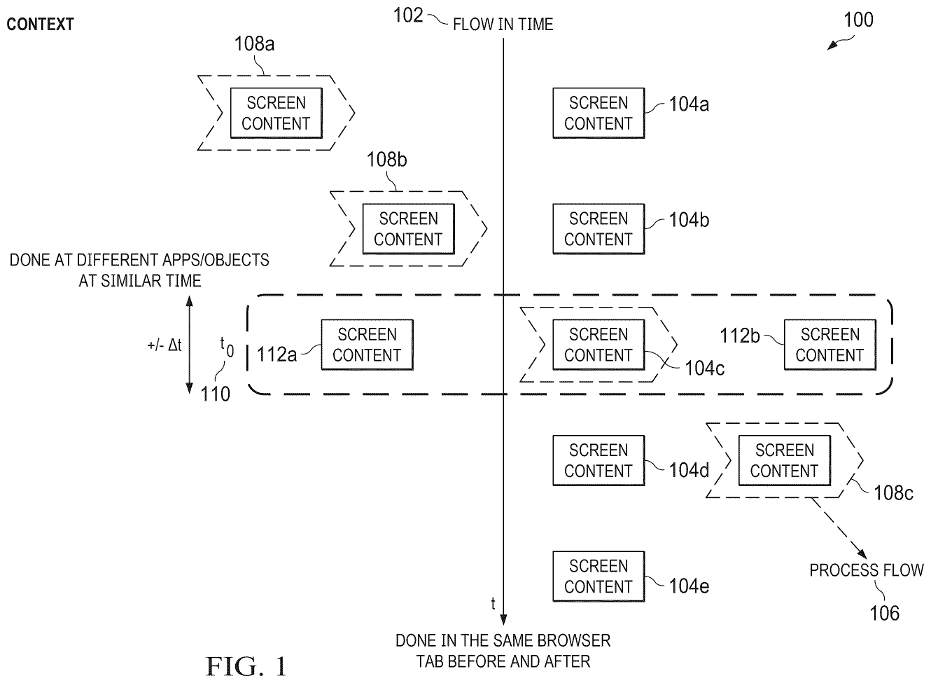

FIG. 1 is a chart 100 illustrating an example of visualization of context considerations for a context-aware personal application memory (PAM), according to an implementation of the present disclosure.

Capturing data from UIs, storing the data and providing search access to the data can be seen as a first step, but adding semantics and context the data was captured in, as well as intuitive access, is crucial for acceptance of the approach to increase user effectiveness.

In some implementations, to add context, relevant “metadata” is added to the captured data. For example, metadata can include:
The app-ID and/or app name.
Time information: The point in time a screen was shown, when it was replaced with different content, and the active time spent on this screen. This permits adding context to answer questions in at least three ways:
   What is done at the same time (range)?
   What has been done (immediately) before and after this screen?
   What fraction of a working day did the user spend on this screen working with a certain object?
Navigation information:
   For one screen, add the link to the screen the navigation was coming from.
   This can be used to create a bidirectionally linked list/tree of screens, the predecessor and successor screens as experienced by the individual user.
Semantic organization of data on the screen, typically defined by an UI library:
   Hierarchy (Tree in a UI library).
      Some types of apps are structured “hierarchically for example, help documentation, Wiki pages, but also company portals.
      For example:
         Someone at a company->compensation->payroll->online pay slip->pay statement for month.
         reporting->solution operations->Service Level Agreements (SLAs)->availability->issues->one specific outage.
   Guided procedures (Wizard in a UI library).
      One typical application pattern to structure steps to be executed is a “guided procedure”, for example, a series of data entry screens presented in a defined order to stepwise capture all required data.
      Such as:
         Shopping cart->address->payment->checkout.
   Timeline.
      Typical organization of events with time stamps.
Semantic relation of screens and the data shown as used in processes:
   Process data.
      An example would be a “Sourcing Process”: Process RFQ (“request for quotation”)>Select Suppliers: When a supplier is chosen (save/next), store not only the supplier data but also the UI and base data of the RFQ the supplier is selected for (likely not visible on the screen at this point, but available in the backend).
      This would, for example, allow to answer question like “which supplier did I choose for the RFQ of company X?”
   Workflow.
      Workflows are a typical organization of actions.
      Asking for an “Approval”: “when,” “about what,” “to whom is it sent,” “what is the status,” “who approved/rejected it,” “reason.”
UI graphics and graphic metadata.
   Capture the image of a data visualization chart or analytics UI and the image metadata, especially the coloring of certain data sets and the data set labels.

In some implementations, related data can also be added. For example, related data can include:
Master data information.
   If data is shown on a screen, only some attributes are shown, typically, the object is related to one or the other master data records, but not all details. For example, for an item in a sales order, there is master data record about the warehouse, shipping information, size and weight, rating if it is critical during shipment, needs to be cooled etc.
Add app internal information
   Status and action management status, like: “initial “in process “aborted “completed.”
   Filter settings configured by the user on a table view or analytics screen, like: “region=Americas “country=US “category=real-estate “balance>$10M.
   Screen configuration, which columns are visible and hidden in tables.
External content.
   Screen reading external content on a first level.
   Store the screen content and the url.

The data is amended to include semantic relations and partially needs to be transformed into information which can be used by a search function and a prompt of the LLM. For example:
For time aspects:
   Screens shown within a certain time span (for example, 1 min) are related as “simultaneous.”
   For screens within one tab, the screen before and after a certain screen can be tagged as “immediately before” and “immediately after.”
   Transform time stamps and time ranges into “after,” “before,” “during.”
For a guided procedure:
   “Me“—“my shopping cart“—“my address“—“my payment method”—
   Checkout process: “initial checkout step“−“checkout step 2: address”-“checkout step 3: payment“−“final checkout step: confirmation.”
For a hierarchy:
   “reporting “reporting on solutions operation “SLA reporting on solution operation “availability reporting of solution operation “reporting on issues with availability “outage report for availability violation . . . .”
A developer is enabled to provide semantic description of the data on the screen and the relations of the data records on the screen.
   For some UI building blocks, this can be specified generically.
   For other UIs, the developer can specify this for an app-UI individually, for example, formulate the relation of data records in the screen with statements with placeholders for the data records.
   The developer can also generate an abstract (semantic summary) based on app name, screen title, focus tags (see above), navigation and hierarchy information and put this into context with key data from the screen.
   The statement is upon capturing update with the actual records shown on the UI and sent with the screen as metadata to the memory.
Set focus tags for data in the UI screens.
   This can be specified by the app screen, like “payment “confidential.”
   This can be specified by related master data (such as, “dangerous goods “hazardous goods”, “to be cooled goods”).

Turning to FIG. 1, a flow of time 102 is indicated from top to bottom. In the example of FIG. 1, the screen content displayed in 104a-104e can be performed in a same browser tab through the flow of time 102.

A process flow 106 is also indicated describing screen content across different applications/data objects through the flow of time 102. For example, running diagonally from upper left to lower right, 106a, 106b, 104c, and 108c could represent a process using four different applications displaying screen content on a UI for each application through the flow of time 102.

Time 110 indicates a time frame for operations taking place at a similar point in time t0 with +/−delta t. Within time 110, operations 112a, 104c, and 112b can take place with different apps and data objects at the similar point in time to.

Data Extractor: Application Memory Interface (AMIF).

To capture data to be stored in the PAM, data to be sent to a UI can be read, but as described in the previous section, it is desired to additionally capture context information. In the described approach an AMIF is designated. AMIF is called by a UI interface, which sends content sent to the UI also to the AMIF.

In some implementations, AMIF is called by a user session manager in an application specifying a user-ID of a user calling the application, and the app-screen-ID of an application UI. AMIF can call an Application Object Instance (AOI) method to obtain additional object data, internal metadata, like status variables, and IDs of related master data objects. With master data object IDs, AMIF can query a Master Data Interface to obtain significant master data.

Using the app-screen-ID, AMIF can query the UI repository for screen related metadata and semantics and add the data generically for capturing.

In some implementations, developers can provide a method to return a textual summary of object content, optionally an abstract with focus on a certain intent (for example, “cost,” “dimensions”). Furthermore, developers can provide a method to provide data values of objects with the indicated object-ID.

In some implementations, developers can provide additional information for an object or application type, which is “implicit” by design, but is helpful to be made explicit for an external memory. For example:
Status and Action Management (SAM): internal status values.
   These are typically not exposed on the UI or provided in an abstract.
   Adding the status value as tags to the data enables PAM to filter and search for the values.
   For example: {“object-status”: “new”} or {“object-status”: “in process”} etc.
For Self-Service applications: add the user information to the record sent to PAM, optionally extended by basic hierarchical context information (for example, direct manager of a user).
   For example: {“user-ID”: “D01234 “user-name”: “John Doe “object-owner”: “self”}.
Error messages:
   For exmaple: {“user-ID”: “D01234 “user-name”: “Volker Driesen “error-ID”: “E23012 “error-text”: “The user D01234 does not have the privileges to access these objects “object-type”: “Employee Contract”}.

In some implementations, AMIF filters the data to be sent to the PAM:
Programmed filtering by the app developer configuring the AMIF usage:
   Not sending the data of entry pages to apps, only that the page has been called.
   For example, do not send the complete “inbox content but only “inbox of user . . . ” called. Only add content once a specific item is displayed in detail. Similarly for monitoring pages.
Automatic filtering by AMIF depending on the situation:
   Send data shown on the UI, not data outside of view, for example, if the columns are configured to be “hidden.”
   Sending data dependent on the time a user has spent on the page (ideally an active time on the UI excluding idle time).
      For pages called only for a short period, for example, to navigate to another page, send the page url and a page abstract.

In some implementations, AMIF is fine-tuned by a customer-specific AMIF Filter Config.
Can be fine-tuned by admins centrally to filter out data not to be sent:
   Removing data being categorized as “person related” or “confidential.”
   For example: in employee data, salaries,
   For example: in customer contracts, a discount, a customer-rating.

Personal Application Memory (PAM) Application.

In some implementations, a PAM application provides user-specific data storage and a UI. Data is sent by the AMIF from applications to the PAM application. AMIF sends data read during the user actions with the applications.

A PAM stores data of received records. Data is stored for each individual user-meaning that there is no cross-user data access possible. The data is stored with a timestamp, the data was captured at. If a successor data set is sent (same app-ID+session), a time range the data set was viewed can be computed. The data which is read from a UI communication is stored. Captured context is stored. Data is stored with full text search capabilities. Linking of records is stored, for example: 1) a process step instance, 2) a predecessor the navigation was coming from; and 3) successor information can be added to the predecessor record.

In some implementation, content can include:
Timestamp.
   A time when this record was captured.
End timestamp (if available).
   A time when the respective page was overwritten, reloaded or replaced.
App-ID and app-name.
   The application name.
Abstract.
   Abstract of a screen shown.
Structured data.
   The captured data in a structured format, for example, JavaScript Object Notation (JSON). The file can contain the fields shown with the field labels on the UI and the data records shown.
Semantically enriched data.
   The captured data put into a semantic context.
   This can be generated via generic UI mapping (for example, from the wizard, tree or timeline).
   This can also be generated application screen specific by a module of the screen developer bringing the data into the semantic context.
Additional context.
   The captured data in a structured format.
   The process data (for example, scientific, business, or educational).
   The master data, private data.

The PAM provides a search interface on a PAM UI for retrieving content. In some implementations, the PAM UI can provide a query prompt, the query being applied only to data, which is specified by filter criteria. The search is executed using a full text search index. For example: 1) search will provide a list of records, a search tag was found in and 2) the user can then show the details of the records, including the time stamps, app-IDs and context.

In some implementations, a PAM can visualize content stored in the memory on the PAM UI (for example, with a table like format listing the records with the time stamps and the app-ID and ideally an abstract of the data recorded. The detail data will be rather heterogeneous. Filtering can be provided using the previously mentioned filter criteria. For example, searching directly on time and app-ID, and for more heterogeneous data, searching using a “name-value” pair search:
Restrict the “date and time” of the records to only show those of certain time range,
Select app-names, for example, only the “Order Entry” app,
To filter for records on the heterogeneous data sets, one can, for example:
   Specify a search tag-records which contain the search tag are kept.
   Specify an attribute name and a value-records which contain the attribute are filtered and from this subset those with the correct value. For example, using a JSON format for the structured data.

Optionally, the PAM can use a LLM service to create a natural language summary to a user query/question. Since not all the information in the personal application memory can be sent to the LLM to compute the answer to the question (due to, among other things, LLM sizing/processing limits), the PAM first has to be filtered (using filter criteria) for relevant information. Then, a user query/question and filtered information read from the PAM can be passed to the LLM to compute the answer. Therefore, the information in the PAM needs to serve two steps in this process: 1) the information to enable the filtering and search for relevant records and 2) the information and semantic context in the record to enable the LLM to compute an appropriate answer.

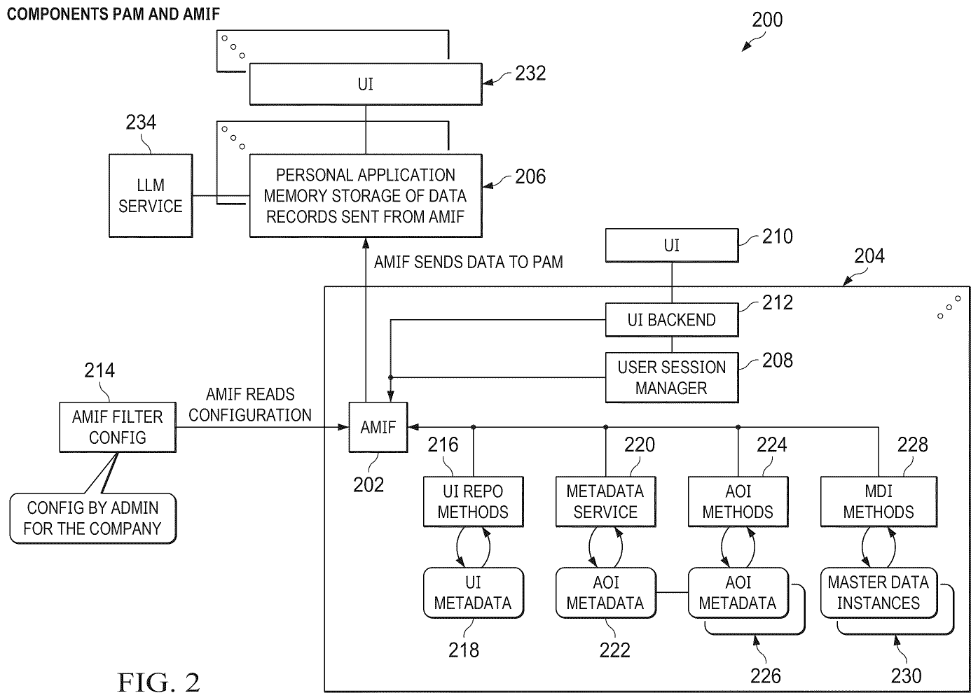

FIG. 2 is a block diagram 200 illustrating additional components and interactions of a context-aware PAM system with respect to an Application Memory Interface (AMIF), according to an implementation of the present disclosure.

In some implementations, components of a PAM system can include an AMIF 202. The AMIF 202 reads data from an application 204. For example, data can include User ID, what a user (managed by a User Session Manager 208) did, an Object ID being viewed, changes to the object (if there are changes), the predecessor screen the navigation was coming from (for example on a UI 210/UI backend 212), adds time and context, and/or adds hidden parameters and master data, configured by the application owner to be added.

In some implementations, the AMIF can also filter data. Filtering data can include programmed filtering by application developers, automatic filtering within the AMIF module, and/or filters defined by administrators centrally for all users. The AMIF 202 can read a configuration (for example, AMIF Filter Config 214) defining various aspects of filtering operations.

Filtering takes place whenever data is sent to PAM. At a high-level, filtering occurs when a user submits or receives data from the UI and at a beginning and end of a user session.

In some implementations, the AMIF can send a data package to a PAM 206 for each user action in an application (for example, application 204). The data package can include data being attributed with date and time and the app- or service name, structured data being provided (for example, as a JSON string), unstructured data being provided as text, and/or capture an image of a data visualization chart or analytics UI and image metadata, especially coloring of certain data sets and the data set labels.

In some implementations, the AMIF 202 is called by the UI backend 212, which sends content which is sent to the UI 210 to the AMIF 202.

In some implementations, the AMIF 202 is called by the User Session Manager 208 in the application 204. The User Session Manager specifies the user-ID of the user calling the Application 204 and the app-screen-ID of the Application 204 UI display.

In some implementations, AMIF 202 can query a UI repository (repo) 216 for screen-related UI metadata (and semantics) 218. This data can be generically added for capturing.

In some implementations, AMIF 202 can query a metadata service 220 to obtain Application Object Instance (AOI) metadata (such as, data type information about data object fields to identify their semantics (for example, name, street, city, description, material number, and customer id) from an AOI metadata repository 222.

In some implementations, developers can provide AOI methods 224 to return a textual summary of an object's content from an AOI instance repository 226. Optionally an abstract with focus on a certain intent (for example, “cost”, “dimensions”) can be returned. AMIF 202 can call the AOI methods 224 to obtain additional object data, internal meta data (such as, status variables and IDs of related master data objects).

In some implementations, developers can provide a Master Data Interface (MDI) methods 228 to provide data values of objects with a specified ID from a repository of Master Data Instances 230. Developers can provide additional information for an object or application type, which is implicit by design, but is helpful to be made explicit for external memory. In this way, AMIF 202 can obtain significant master data for objects.

In some implementations, the PAM 206 can store data in encrypted form and provide authenticated access. In storing data, the PAM 206 can encapsulate data for each user, preventing cross-user data access.

In some implementations, the PAM 206 can store data, both structured and unstructured. The stored data can have common attributes for all records, such as date and time, app- or service name; record individual attributes, such as object identifier, object attributes, uniform resource locator (URL) to show object details; store text with a search-index supporting fuzzy search; and/or have semantic context for the data in the records.

In some implementations, the PAM 206 has a UI 232 to permit a user to enter data, their own records or annotations to existing records; filter data (for example, UI filtering capability), select a certain time-range, app-type or filter for records containing certain search-strings; and/or search for a string, including fuzzy search. As an example, a query prompt could include a user entering a natural language question into the UI, such as a query prompt “Which objects did I change between 10:00 am and 10:15 am today?” As previously described, the added context information and relation-information supports intuitive processing of/access to information using LLMs (for example, LLM 234).

FIG. 3 is a flowchart illustrating an example of a computer-implemented method 300 for a context-aware PAM, according to an implementation of the present disclosure. For clarity of presentation, the description that follows generally describes method 300 in the context of the other figures in this description. However, it will be understood that method 300 can be performed, for example, by any system, environment, software, and hardware, or a combination of systems, environments, software, and hardware, as appropriate. In some implementations, various steps of method 300 can be run in parallel, in combination, in loops, or in any order.

At 302, using an Application Memory Interface (AMIF) and to create captured data from one or more software applications, data related to user actions with the one or more software applications is captured. In some implementations, the captured data includes one or more of a user ID, actions performed by a user, an object ID of a viewed data object, changes to the viewed data object, and a predecessor UI display screen to a UI navigation. From 302, method 300 proceeds to 304.

At 304, using the AMIF and to create enhanced data, the captured data is enhanced with metadata, data, and semantic relations. In some implementations, metadata includes application ID or application name, time information, navigation information, semantic organization of data on a UI display screen, semantic relations of UI display screens and data shown as used in processes, and UI graphics and graphic metadata. In some implementations, data includes master data information, software application internal information, and external content. In some implementations, semantic relations include time aspects of UI display screens, guided procedure data, hierarchical operations, developer provided semantic descriptions for data on the UI display screens, and focus tags for the data on the UI display screens. From 304, method 300 proceeds to 306.

At 306, using the AMIF and to create filtered data, the enhanced data is filtered. In some implementations, filtering includes programmed filtering by a software application developer and situational automatic filtering, and where filtering uses a filter configuration to remove data from being stored in the PAM. In some implementations, the PAM stores the filtered data in an encrypted format, provides authenticated access to the filtered data, and encapsulates the filtered data for each user. From 306, method 300 proceeds to 308.

At 308, the filtered data is sent by the AMIF to a personal application memory (PAM). In some implementations, using a PAM UI and a provided query prompt, a user query can be received, where the user query includes filter criteria, and where the user query is applied to data specified by the filter criteria. The user query is processed and the user query and heterogenous query results of the user query are returned to the PAM UI. In some implementations, using a PAM UI, a user query is received. Based on the user query and filter criteria and as filtered PAM data, the filtered data stored in the PAM is filtered. The user query and the filtered PAM data is transmitted to a large language model for processing and a natural language summary is returned as query results of the user query to the PAM UI. After 308, method 300 can stop.

FIG. 4 is a block diagram illustrating an example of a computer-implemented System 400 used to provide computational functionalities associated with described algorithms, methods, functions, processes, flows, and procedures, according to an implementation of the present disclosure. In the illustrated implementation, System 400 includes a Computer 402 and a Network 430.

The illustrated Computer 402 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 402 can include an input device, such as a keypad, keyboard, or touch screen, or a combination of input devices that can accept user information, and an output device that conveys information associated with the operation of the Computer 402, including digital data, visual, audio, another type of information, or a combination of types of information, on a graphical-type user interface (UI) (or GUI) or other UI.

The Computer 402 can serve in a role in a distributed computing system as, for example, a client, network component, a server, or a database or another persistency, or a combination of roles for performing the subject matter described in the present disclosure. The illustrated Computer 402 is communicably coupled with a Network 430. In some implementations, one or more components of the Computer 402 can be configured to operate within an environment, or a combination of environments, including cloud-computing, local, or global.

At a high level, the Computer 402 is an electronic computing device operable to receive, transmit, process, store, or manage data and information associated with the described subject matter. According to some implementations, the Computer 402 can also include or be communicably coupled with a server, such as an application server, e-mail server, web server, caching server, or streaming data server, or a combination of servers.

The Computer 402 can receive requests over Network 430 (for example, from a client software application executing on another Computer 402) and respond to the received requests by processing the received requests using a software application or a combination of software applications. In addition, requests can also be sent to the Computer 402 from internal users (for example, from a command console or by another internal access method), external or third-parties, or other entities, individuals, systems, or computers.

Each of the components of the Computer 402 can communicate using a System Bus 403. In some implementations, any or all of the components of the Computer 402, including hardware, software, or a combination of hardware and software, can interface over the System Bus 403 using an application programming interface (API) 412, a Service Layer 413, or a combination of the API 412 and Service Layer 413. The API 412 can include specifications for routines, data structures, and object classes. The API 412 can be either computer-language independent or dependent and refer to a complete interface, a single function, or even a set of APIs. The Service Layer 413 provides software services to the Computer 402 or other components (whether illustrated or not) that are communicably coupled to the Computer 402. The functionality of the Computer 402 can be accessible for all service consumers using the Service Layer 413. Software services, such as those provided by the Service Layer 413, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 402, alternative implementations can illustrate the API 412 or the Service Layer 413 as stand-alone components in relation to other components of the Computer 402 or other components (whether illustrated or not) that are communicably coupled to the Computer 402. Moreover, any or all parts of the API 412 or the Service Layer 413 can be implemented as a child or a sub-module of another software module, enterprise application, or hardware module without departing from the scope of the present disclosure.

The Computer 402 includes an Interface 404. Although illustrated as a single Interface 404, two or more Interfaces 404 can be used according to particular needs, desires, or particular implementations of the Computer 402. The Interface 404 is used by the Computer 402 for communicating with another computing system (whether illustrated or not) that is communicatively linked to the Network 430 in a distributed environment. Generally, the Interface 404 is operable to communicate with the Network 430 and includes logic encoded in software, hardware, or a combination of software and hardware. More specifically, the Interface 404 can include software supporting one or more communication protocols associated with communications such that the Network 430 or hardware of Interface 404 is operable to communicate physical signals within and outside of the illustrated Computer 402.

The Computer 402 includes a Processor 405. Although illustrated as a single Processor 405, two or more Processors 405 can be used according to particular needs, desires, or particular implementations of the Computer 402. Generally, the Processor 405 executes instructions and manipulates data to perform the operations of the Computer 402 and any algorithms, methods, functions, processes, flows, and procedures as described in the present disclosure.

The Computer 402 also includes a Database 406 that can hold data for the Computer 402, another component communicatively linked to the Network 430 (whether illustrated or not), or a combination of the Computer 402 and another component. For example, Database 406 can be an in-memory or conventional database storing data consistent with the present disclosure. In some implementations, Database 406 can be a combination of two or more different database types (for example, a hybrid in-memory and conventional database) according to particular needs, desires, or particular implementations of the Computer 402 and the described functionality. Although illustrated as a single Database 406, two or more databases of similar or differing types can be used according to particular needs, desires, or particular implementations of the Computer 402 and the described functionality. While Database 406 is illustrated as an integral component of the Computer 402, in alternative implementations, Database 406 can be external to the Computer 402. The Database 406 can hold and operate on at least any data type mentioned or any data type consistent with this disclosure.

The Computer 402 also includes a Memory 407 that can hold data for the Computer 402, another component or components communicatively linked to the Network 430 (whether illustrated or not), or a combination of the Computer 402 and another component. Memory 407 can store any data consistent with the present disclosure. In some implementations, Memory 407 can be a combination of two or more different types of memory (for example, a combination of semiconductor and magnetic storage) according to particular needs, desires, or particular implementations of the Computer 402 and the described functionality. Although illustrated as a single Memory 407, two or more Memories 407 or similar or differing types can be used according to particular needs, desires, or particular implementations of the Computer 402 and the described functionality. While Memory 407 is illustrated as an integral component of the Computer 402, in alternative implementations, Memory 407 can be external to the Computer 402.

The Application 408 is an algorithmic software engine providing functionality according to particular needs, desires, or particular implementations of the Computer 402, particularly with respect to functionality described in the present disclosure. For example, Application 408 can serve as one or more components, modules, or applications. Further, although illustrated as a single Application 408, the Application 408 can be implemented as multiple Applications 408 on the Computer 402. In addition, although illustrated as integral to the Computer 402, in alternative implementations, the Application 408 can be external to the Computer 402.

The Computer 402 can also include a Power Supply 414. The Power Supply 414 can include a rechargeable or non-rechargeable battery that can be configured to be either user- or non-user-replaceable. In some implementations, the Power Supply 414 can include power-conversion or management circuits (including recharging, standby, or another power management functionality). In some implementations, the Power Supply 414 can include a power plug to allow the Computer 402 to be plugged into a wall socket or another power source to, for example, power the Computer 402 or recharge a rechargeable battery.

There can be any number of Computers 402 associated with, or external to, a computer system containing Computer 402, each Computer 402 communicating over Network 430. Further, the term “client,” “user,” or other appropriate terminology can be used interchangeably, as appropriate, without departing from the scope of the present disclosure. Moreover, the present disclosure contemplates that many users can use one Computer 402, or that one user can use multiple computers 402.

Described implementations of the subject matter can include one or more features, alone or in combination.

For example, in a first implementation, a computer-implemented method, comprising: capturing, using an Application Memory Interface (AMIF) and to create captured data from one or more software applications, data related to user actions with the one or more software applications; enhancing, using the AMIF and to create enhanced data, the captured data with metadata, data, and semantic relations; filtering, using the AMIF and to create filtered data, the enhanced data; and sending, by the AMIF, the filtered data to a personal application memory (PAM).

The foregoing and other described implementations can each, optionally, include one or more of the following features:

A first feature, combinable with any of the following features, wherein the captured data comprises one or more of a user ID, actions performed by a user, an object ID of a viewed data object, changes to the viewed data object, and a predecessor UI display screen to a UI navigation.

A second feature, combinable with any of the previous or following features, wherein: metadata includes application ID or application name, time information, navigation information, semantic organization of data on a UI display screen, semantic relations of UI display screens and data shown as used in processes, and UI graphics and graphic metadata; data includes master data information, software application internal information, and external content; and semantic relations include time aspects of UI display screens, guided procedure data, hierarchical operations, developer provided semantic descriptions for data on the UI display screens, and focus tags for the data on the UI display screens.

A third feature, combinable with any of the previous or following features, wherein filtering comprises programmed filtering by a software application developer and situational automatic filtering, and wherein filtering uses a filter configuration to remove data from being stored in the PAM.

A fourth feature, combinable with any of the previous or following features, wherein the PAM stores the filtered data in an encrypted format, provides authenticated access to the filtered data, and encapsulates the filtered data for each user.

A fifth feature, combinable with any of the previous or following features, comprising: receiving, using a PAM UI and a provided query prompt, a user query, wherein the user query includes filter criteria, and wherein the user query is applied to data specified by the filter criteria; processing the user query; and returning heterogenous query results of the user query to the PAM UI.

A sixth feature, combinable with any of the previous or following features, comprising: receiving, using a PAM UI, a user query; filtering, based on the user query and filter criteria and as filtered PAM data, the filtered data stored in the PAM; transmitting the user query and the filtered PAM data to a large language model for processing; and returning a natural language summary as query results of the user query to the PAM UI.

In a second implementation, a non-transitory, computer-readable medium storing one or more instructions executable by a computer system to perform one or more operations, comprising: capturing, using an Application Memory Interface (AMIF) and to create captured data from one or more software applications, data related to user actions with the one or more software applications; enhancing, using the AMIF and to create enhanced data, the captured data with metadata, data, and semantic relations; filtering, using the AMIF and to create filtered data, the enhanced data; and sending, by the AMIF, the filtered data to a personal application memory (PAM).

The foregoing and other described implementations can each, optionally, include one or more of the following features:

A first feature, combinable with any of the following features, wherein the captured data comprises one or more of a user ID, actions performed by a user, an object ID of a viewed data object, changes to the viewed data object, and a predecessor UI display screen to a UI navigation.

A second feature, combinable with any of the previous or following features, wherein: metadata includes application ID or application name, time information, navigation information, semantic organization of data on a UI display screen, semantic relations of UI display screens and data shown as used in processes, and UI graphics and graphic metadata; data includes master data information, software application internal information, and external content; and semantic relations include time aspects of UI display screens, guided procedure data, hierarchical operations, developer provided semantic descriptions for data on the UI display screens, and focus tags for the data on the UI display screens.

A third feature, combinable with any of the previous or following features, wherein filtering comprises programmed filtering by a software application developer and situational automatic filtering, and wherein filtering uses a filter configuration to remove data from being stored in the PAM.

A fourth feature, combinable with any of the previous or following features, wherein the PAM stores the filtered data in an encrypted format, provides authenticated access to the filtered data, and encapsulates the filtered data for each user.

A fifth feature, combinable with any of the previous or following features, comprising: receiving, using a PAM UI and a provided query prompt, a user query, wherein the user query includes filter criteria, and wherein the user query is applied to data specified by the filter criteria; processing the user query; and returning heterogenous query results of the user query to the PAM UI.

A sixth feature, combinable with any of the previous or following features, comprising: receiving, using a PAM UI, a user query; filtering, based on the user query and filter criteria and as filtered PAM data, the filtered data stored in the PAM; transmitting the user query and the filtered PAM data to a large language model for processing; and returning a natural language summary as query results of the user query to the PAM UI.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations, comprising: capturing, using an Application Memory Interface (AMIF) and to create captured data from one or more software applications, data related to user actions with the one or more software applications; enhancing, using the AMIF and to create enhanced data, the captured data with metadata, data, and semantic relations; filtering, using the AMIF and to create filtered data, the enhanced data; and sending, by the AMIF, the filtered data to a personal application memory (PAM).

The foregoing and other described implementations can each, optionally, include one or more of the following features:

A first feature, combinable with any of the following features, wherein the captured data comprises one or more of a user ID, actions performed by a user, an object ID of a viewed data object, changes to the viewed data object, and a predecessor UI display screen to a UI navigation.

A second feature, combinable with any of the previous or following features, wherein: metadata includes application ID or application name, time information, navigation information, semantic organization of data on a UI display screen, semantic relations of UI display screens and data shown as used in processes, and UI graphics and graphic metadata; data includes master data information, software application internal information, and external content; and semantic relations include time aspects of UI display screens, guided procedure data, hierarchical operations, developer provided semantic descriptions for data on the UI display screens, and focus tags for the data on the UI display screens.

A third feature, combinable with any of the previous or following features, wherein filtering comprises programmed filtering by a software application developer and situational automatic filtering, and wherein filtering uses a filter configuration to remove data from being stored in the PAM.

A fourth feature, combinable with any of the previous or following features, wherein the PAM stores the filtered data in an encrypted format, provides authenticated access to the filtered data, and encapsulates the filtered data for each user.

A fifth feature, combinable with any of the previous or following features, comprising: receiving, using a PAM UI and a provided query prompt, a user query, wherein the user query includes filter criteria, and wherein the user query is applied to data specified by the filter criteria; processing the user query; and returning heterogenous query results of the user query to the PAM UI.

A sixth feature, combinable with any of the previous or following features, comprising: receiving, using a PAM UI, a user query; filtering, based on the user query and filter criteria and as filtered PAM data, the filtered data stored in the PAM; transmitting the user query and the filtered PAM data to a large language model for processing; and returning a natural language summary as query results of the user query to the PAM UI.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
capturing, using an Application Memory Interface (AMIF) and to create captured data from one or more software applications, data related to user actions with the one or more software applications;
enhancing, using the AMIF and to create enhanced data, the captured data with metadata, data, and semantic relations;
filtering, using the AMIF and to create filtered data, the enhanced data; and
sending, by the AMIF, the filtered data to a personal application memory (PAM).

2. The computer-implemented method of claim 1, wherein the captured data comprises one or more of a user ID, actions performed by a user, an object ID of a viewed data object, changes to the viewed data object, and a predecessor UI display screen to a UI navigation.

3. The computer-implemented method of claim 1, wherein:
metadata includes application ID or application name, time information, navigation information, semantic organization of data on a UI display screen, semantic relations of UI display screens and data shown as used in processes, and UI graphics and graphic metadata;
data includes master data information, software application internal information, and external content; and
semantic relations include time aspects of UI display screens, guided procedure data, hierarchical operations, developer provided semantic descriptions for data on the UI display screens, and focus tags for the data on the UI display screens.

4. The computer-implemented method of claim 1, wherein filtering comprises programmed filtering by a software application developer and situational automatic filtering, and wherein filtering uses a filter configuration to remove data from being stored in the PAM.

5. The computer-implemented method of claim 1, wherein the PAM stores the filtered data in an encrypted format, provides authenticated access to the filtered data, and encapsulates the filtered data for each user.

6. The computer-implemented method of claim 1, comprising:
receiving, using a PAM UI and a provided query prompt, a user query, wherein the user query includes filter criteria, and wherein the user query is applied to data specified by the filter criteria;
processing the user query; and
returning heterogenous query results of the user query to the PAM UI.

7. The computer-implemented method of claim 1, comprising:
receiving, using a PAM UI, a user query;
filtering, based on the user query and filter criteria and as filtered PAM data, the filtered data stored in the PAM;
transmitting the user query and the filtered PAM data to a large language model for processing; and
returning a natural language summary as query results of the user query to the PAM UI.

8. A non-transitory, computer-readable medium storing one or more instructions executable by a computer system to perform one or more operations, comprising:
capturing, using an Application Memory Interface (AMIF) and to create captured data from one or more software applications, data related to user actions with the one or more software applications;
enhancing, using the AMIF and to create enhanced data, the captured data with metadata, data, and semantic relations;
filtering, using the AMIF and to create filtered data, the enhanced data; and
sending, by the AMIF, the filtered data to a personal application memory (PAM).

9. The non-transitory, computer-readable medium of claim 8, wherein the captured data comprises one or more of a user ID, actions performed by a user, an object ID of a viewed data object, changes to the viewed data object, and a predecessor UI display screen to a UI navigation.

10. The non-transitory, computer-readable medium of claim 8, wherein:
metadata includes application ID or application name, time information, navigation information, semantic organization of data on a UI display screen, semantic relations of UI display screens and data shown as used in processes, and UI graphics and graphic metadata;
data includes master data information, software application internal information, and external content; and
semantic relations include time aspects of UI display screens, guided procedure data, hierarchical operations, developer provided semantic descriptions for data on the UI display screens, and focus tags for the data on the UI display screens.

11. The non-transitory, computer-readable medium of claim 8, wherein filtering comprises programmed filtering by a software application developer and situational automatic filtering, and wherein filtering uses a filter configuration to remove data from being stored in the PAM.

12. The non-transitory, computer-readable medium of claim 8, wherein the PAM stores the filtered data in an encrypted format, provides authenticated access to the filtered data, and encapsulates the filtered data for each user.

13. The non-transitory, computer-readable medium of claim 8, comprising:
receiving, using a PAM UI and a provided query prompt, a user query, wherein the user query includes filter criteria, and wherein the user query is applied to data specified by the filter criteria;
processing the user query; and
returning heterogenous query results of the user query to the PAM UI.

14. The non-transitory, computer-readable medium of claim 8, comprising:
receiving, using a PAM UI, a user query;
filtering, based on the user query and filter criteria and as filtered PAM data, the filtered data stored in the PAM;
transmitting the user query and the filtered PAM data to a large language model for processing; and
returning a natural language summary as query results of the user query to the PAM UI.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
capturing, using an Application Memory Interface (AMIF) and to create captured data from one or more software applications, data related to user actions with the one or more software applications;
enhancing, using the AMIF and to create enhanced data, the captured data with metadata, data, and semantic relations;
filtering, using the AMIF and to create filtered data, the enhanced data; and
sending, by the AMIF, the filtered data to a personal application memory (PAM).

16. The computer-implemented system of claim 15, wherein the captured data comprises one or more of a user ID, actions performed by a user, an object ID of a viewed data object, changes to the viewed data object, and a predecessor UI display screen to a UI navigation.

17. The computer-implemented system of claim 15, wherein:
metadata includes application ID or application name, time information, navigation information, semantic organization of data on a UI display screen, semantic relations of UI display screens and data shown as used in processes, and UI graphics and graphic metadata;
data includes master data information, software application internal information, and external content; and
semantic relations include time aspects of UI display screens, guided procedure data, hierarchical operations, developer provided semantic descriptions for data on the UI display screens, and focus tags for the data on the UI display screens.

18. The computer-implemented system of claim 15, wherein filtering comprises programmed filtering by a software application developer and situational automatic filtering, and wherein filtering uses a filter configuration to remove data from being stored in the PAM.

19. The computer-implemented system of claim 15, wherein the PAM stores the filtered data in an encrypted format, provides authenticated access to the filtered data, and encapsulates the filtered data for each user.

20. The computer-implemented system of claim 15, comprising:
receiving, using a PAM UI and a provided query prompt, a user query, wherein the user query includes filter criteria, and wherein the user query is applied to data specified by the filter criteria;
processing the user query; and
returning heterogenous query results of the user query to the PAM UI.
